(19) United States
(12) Patent Application Publication
(10) Pub. No.: US 2026/0065370 A1
(43) Pub. Date: Mar. 5, 2026

(54) SYSTEM AND METHOD FOR IMPLEMENTING AN ANALYTICS TOOL FOR PURCHASE PRICE ALLOCATION BENCHMARKING

(71) Applicant: KPMG LLP, New York, NY (US)

(72) Inventors: Alan Zhao, Fremont, CA (US); Sai Elluri, Denver, CO (US); Andrew Goodman, Salt Lake City, UT (US); Dhaval Kapadia, Fair Lawn, NJ (US)

(21) Appl. No.: 19/313,114

(22) Filed: Aug. 28, 2025

Related U.S. Application Data
(60) Provisional application No. 63/688,447, filed on Aug. 29, 2024.

(51) Int. Cl. G06Q 40/04

(52) U.S. Cl. CPC G06Q 40/0431; G06Q 40/0421

(57) ABSTRACT

The invention relates to computer-implemented systems and methods for implementing an Intangibles Analytics Tool that may be used to benchmark purchase price allocation (PPA) data from public filings. The Intangibles Analytics Tool may include the ability to: (i) automatically retrieve acquisition disclosure information and provide initial PPA mapping, replacing the need to perform these steps manually and (ii) serve as a database of verified public PPA data that may be leveraged across offices, applications, industries, etc. With the Intangibles Analytics Tool, users may perform transaction searches and automatically retrieve filings associated with the buyers of those transactions.

### CROSS-REFERENCE TO RELATED APPLICATIONS

The application claims priority to U.S. Provisional Application 63/688,447 (Attorney Docket No. 055089.0000128), filed August 29, 2024, the contents of which are incorporated by reference herein in their entirety.

### FIELD OF THE INVENTION

The present invention generally relates to purchase price allocation benchmarking and analytics and more specifically to a cloud-based analytics tool hosted on a platform that retrieves and normalizes purchase price allocation data from various sources and validates transaction data in a centralized database for enhanced analytics.

### BACKGROUND

In business acquisitions, any asset involved in a transaction must be properly valued and recognized on financial statements. This process, known as purchase price allocation (PPA), involves distributing the total purchase price among various acquired assets and liabilities, including tangible assets, intangible assets, and goodwill. Purchase price allocation (PPA) refers to an application of goodwill accounting where one company (the acquirer) purchases a second company (the target) and allocates the purchase price into various assets and liabilities acquired from the transaction. Intangible assets can encompass a wide range of items such as customer relationships, developed technology, trade names and other intellectual property that may be challenging to value due to their non-physical nature.

Most public companies disclose asset values from their acquisitions in public filings submitted to regulatory bodies. However, each company values assets differently and presents these values in their own format and location within their filings. There is no standardized approach for where acquisition disclosures appear within documents, nor is there consistency in how companies present the underlying data. Some companies may include detailed breakdowns in footnotes, while others may provide summary information in different sections of their reports.

When performing new valuations, financial professionals typically use historical valuations in relevant industries or technology sectors as benchmarks to assess the reasonableness of their conclusions. This benchmarking process involves identifying comparable transactions, extracting relevant valuation data, and analyzing the relationships between different asset categories and overall transaction values. The data from these historical transactions is maintained separately across different formats and sources, making comprehensive analysis challenging.

Because there is no standardization, the current infrastructure makes it difficult for users to collaborate across multiple data sources. The current process is manual, prone to errors and oftentimes results in duplicate efforts and significant inefficiencies. Oftentimes, the data is retrieved manually in a time-consuming manner and lacks depth or any useful analytics. The absence of standardized collection and analysis methods can lead to inconsistencies in how data is interpreted and applied across different projects and teams.

It would be desirable, therefore, to have a system and method that could overcome the foregoing disadvantages of known systems.

### SUMMARY

According to an embodiment, the invention relates to a computer-implemented system that implements a purchase price allocation benchmarking and analytics tool. The system comprises: a data collection input interface that collects data from a plurality of disparate data sources; a centralized database that stores, normalizes and manages the collected data; and a computer processor that is coupled to the data collection input and the centralized database and further programmed to perform the steps of: collecting, via the data collection input interface, transaction data from the plurality of disparate data sources comprising company public filings, eXtensible Business Reporting Language (XBRL) data and financial research platform data; executing, via the computer processor, a mapping algorithm that normalizes and standardizes the transaction data from company public filings; executing, via the computer processor, a matching algorithm that associates the transaction data with corresponding financial research platform data; validating, via the computer processor, the transaction data to identify a validation status representing a level of validation; generating, via the computer processor, one or more searches for the validated transaction data; and presenting, via a user interface, an interactive dashboard that comprises source data content and corresponding analytics relating to the transaction data specific to a combination of: Intangibles data; Goodwill / property, plant, and equipment (PP&E) data; Enterprise Value; or Financial Research Data.

According to another embodiment, the invention relates to a computer-implemented method that implements a purchase price allocation benchmarking and analytics tool. The method comprises the steps of: collecting, via a data collection input interface, transaction data from the plurality of disparate data sources comprising company public filings, eXtensible Business Reporting Language (XBRL) data and financial research platform data; executing, via a computer processor, a mapping algorithm that normalizes and standardizes the transaction data from company public filings; executing, via the computer processor, a matching algorithm that associates the transaction data with corresponding financial research platform data; validating, via the computer processor, the transaction data to identify a validation status representing a level of validation; generating, via the computer processor, one or more searches for the validated transaction data; and presenting, via a user interface, an interactive dashboard that comprises source data content and corresponding analytics relating to the transaction data specific to a combination of: Intangibles data; Goodwill / property, plant, and equipment (PP&E) data; Enterprise Value; or Financial Research Data.

The invention also relates to a computer-readable medium containing program instructions for executing a method that implements a purchase price allocation benchmarking and analytics tool.

An embodiment of the present invention is directed to a cloud-based tool that may be hosted on various platforms, including a Tax Automation Platform, that automatically retrieves purchase price allocation (PPA) benchmarking data from various sources including 10-K filings using XBRL SEC filings. XBRL (eXtensible Business Reporting Language) is an open international standard for digital business reporting maintained by XBRL International.

With an embodiment of the present invention, automated retrieval of PPA disclosures from 10-K public filings may be mapped to intangible asset categories for user review, data analysis, predictions and/or outputs. Validated transactions may be stored in a centralized database as information accumulates over time. In addition, Public PPA data may be blended with other quantitative and qualitative transactional data. Advanced and interactive visualizations on PPA data may be available for various users, use cases, applications as well as integration with systems and platforms.

Other functionality may include: additional S&P Capital IQ market data integration; enhanced search and benchmarking functionalities; and additional advanced market and industry analytics. An embodiment of the present invention may support a wide range of use cases including: pre-deal preliminary purchase price allocation benchmarking; identification of primary assets across similar M&A transactions within industries; and an ability to support conclusions reached in ASC 805 analyses.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary system diagram, according to an embodiment of the present invention.

FIG. 2 is an exemplary flow diagram, according to an embodiment of the present invention.

FIG. 3 illustrates an exemplary user interface, according to an embodiment of the present invention.

FIG. 4 illustrates an exemplary user interface, according to an embodiment of the present invention.

FIG. 5 illustrates an exemplary user interface, according to an embodiment of the present invention.

FIG. 6 illustrates an exemplary user interface, according to an embodiment of the present invention.

### DETAILED DESCRIPTION

Exemplary embodiments of the invention will now be described to illustrate various features of the invention. The embodiments described herein are not intended to be limiting as to the scope of the invention, but rather are intended to provide examples of the components, use, and operation of the invention.

An embodiment of the present invention is directed to a data-driven Intangibles Analytics Tool that sources data from various entities including: Public filings via SEC Edgar, Capital IQ, and System Users. Through decision logic, the Intangibles Analytics Tool may find and retrieve information from relevant sections of various sources in different formats and standardize the information retrieved into a useable form. An embodiment of the present invention may incorporate Generative Artificial Intelligence (Gen AI) by executing a persona (e.g., financial evaluation consultant) to perform data retrieval, data aggregation (e.g., data matching across multiple data sources) and dynamic data filtering and searches (e.g., automated searches) with high accuracy, speed and confidence.

An embodiment of the present invention provides a centralized repository/database of formatted and standardized data that supports dynamic collaboration across teams, locations, projects, etc. This further eliminates duplication of efforts and promotes speed, efficiency and consistency. In addition, the centralized repository/database maintains data that has been validated and reviewed on multiple levels as demonstrated by visual indicators that show underlying data points are accurate, validated and properly reviewed. This enables users to rely on the validated data with confidence and enhanced understanding. Users also have the ability to edit data, overwrite data and also add new data as needed. In addition, users may view a history of edits and other actions to verify and confirm accuracy and authenticity.

An embodiment of the present invention is directed to generating outputs including reports and other interfaces with standardized data across separate disparate sources each having different scopes. The Intangibles Analytics Tool may be used to perform data analytics, execute targeted searches and generate predictions. In addition, an embodiment of the present invention may assign weights and/or apply rankings to certain sources or data formats based on accuracy, historical performance and/or other metric.

An embodiment of the present invention is directed to an Intangibles Analytics Tool that may be used to benchmark purchase price allocation (PPA) data from public filings. Technical benefits of the Intangibles Analytics Tool may include the ability to: (i) automatically retrieve acquisition disclosure information and provide initial PPA mapping, replacing the need to perform these steps manually and (ii) serve as a centralized database of verified public PPA data that may be leveraged across offices, applications, industries, etc.

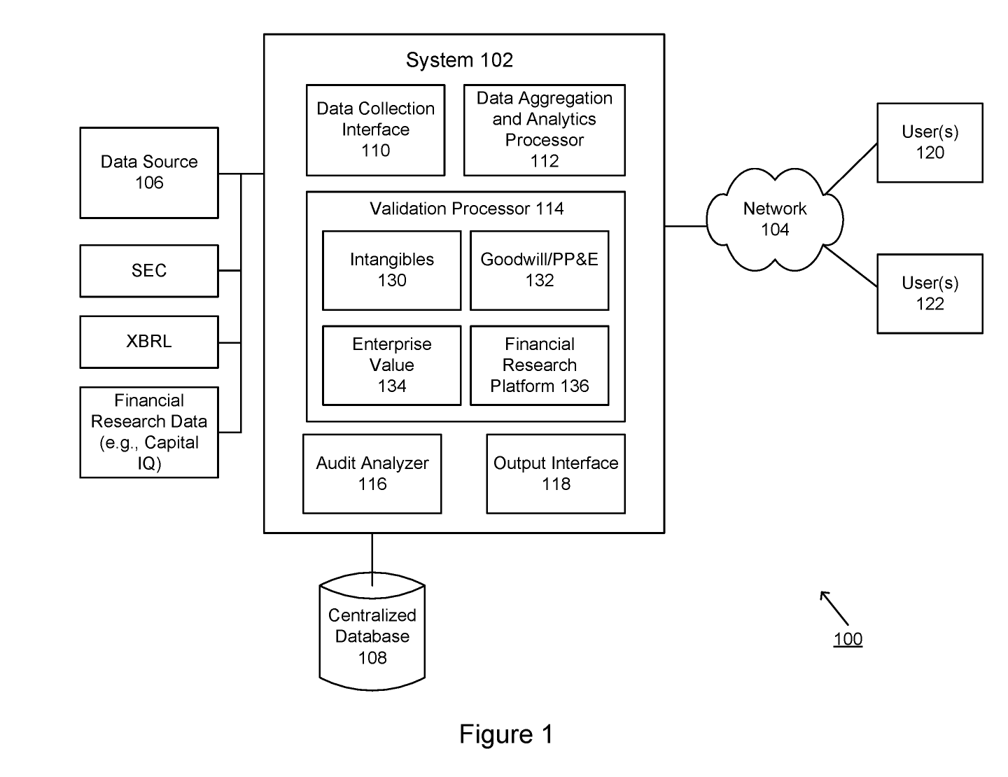

FIG. 1 is an exemplary system diagram, according to an embodiment of the present invention. As shown in FIG. 1, User(s) 120, 122 may access System 102 via Network 104. System 102 may receive data from various sources represented by Data Source 106 which may include internal as well as external sources of information. System 102 may be a stand-alone system or integrated with various other systems and platforms. Other implementations and architectures may be supported.

System 102 may support various features and functions represented by Data Collection Interface 110, Data Aggregation and Analytics Processor 112, Validation Processor 114, Audit Analyzer 116, and Output Interface 118.

Data Source 106 may represent: Public Filings, Capital IQ and data from system users. Public filings via SEC Edgar provide descriptions of transactions listed in public filings. The data may include buyer company name, seller company name, purchase price build up, and various financial line items and values associated with the transaction. An embodiment of the present invention may expand beyond US transactions and include foreign transactions.

Capital IQ provides company business descriptions and company financials such as market capitalization, revenue, EBITDA (Earnings Before Interest, Taxes, Depreciation and Amortization), etc. Capital IQ represents a financial research platform that provides data on public and private companies, investment firms, transactions and individuals. Capital IQ is one example; other platforms may be implemented in accordance with the various embodiments of the present invention.

System Users may serve as reviewers of the data collected and ultimately validate and approve the accuracy as well as edit the data as needed to ensure enough detail is provided and values are accurate. According to an embodiment of the present invention, review, validation and corrections may be performed automatically.

Data Collection Interface 110 may receive/ingest input data from various data sources, including Data Source 106. Data Collection Interface 110 may implement specialized processing capabilities for handling various data formats and sources that contribute to the comprehensive transaction analysis functionality. In some cases, Data Collection Interface 110 may receive data from Securities and Exchange Commission (SEC) databases, XBRL, financial research platforms (e.g., Capital IQ), and user input systems that provide transaction information in different formats and structures. Data Collection Interface 110 may process this incoming data to extract relevant transaction details and prepare the information for subsequent analysis and validation operations.

Data collection from the various data sources may involve various intake methods. For Public Filings, an embodiment of the present invention may use a mapping logic to map XBRL tags to financial line items of interest. The XBRL tagging that underlies the data is then scraped to pull transaction details.

In addition, a unique Gen AI prompt/persona may scrape the financial information of interest from the text version of public filings. The unique Gen AI prompt/persona may be used to supplement/confirm accuracy of results of the mapping logic. For example, the Gen AI prompt/persona may update, edit and/or review data as compared with source document. This promotes management of reviewed/validated data that raises confidence to datapoints. Capital IQ data may be collected via API. Other financial research platforms may be supported. System User data may be collected within the UI via custom mapping boxes. Other user interactions may be captured.

With the Intangibles Analytics Tool, users may perform transaction searches and automatically pull filings associated with the buyers of those transactions. Provided the transaction disclosure information is available, the Tool may provide an initial mapping of the transaction purchase price, PP&E values, and intangible asset categories, values, and their associated remaining useful lives. The Tool may also provide an initial mapping of various transaction details from the Capital IQ database. These initial mappings may be available for users to review and validate, thereby ensuring the accuracy of the data.

The Intangibles Analytics Tool may receive information in various formats including XBRL (eXtensible Business Reporting Language) which is an XML-based file associated with public company filings submitted to the SEC. XBRL technology standard was created as an attempt to standardize business reporting, with the idea of normalizing unstructured data (e.g., variety of filing formats) into structured data form. Other formats may include direct PDF, HTML formats of the files, etc.

The Intangibles Analytics Tool may retrieve XBRL information via an API or other interface. The Tool may periodically retrieve new filings, parse the XML data, and store the information. An embodiment of the present invention recognizes that XBRL data is not the same as the actual filing. While the filing is a formatted document with text and tables submitted by public companies, the XBRL data is an independent .xml-based file that the companies produce alongside the filings. Companies tag certain data points from the filings (XBRL tags) but not all information gets tagged.

Although filings have words and text that humans understand, XBRL tags in its rawest form will need to be mapped and interpreted. For example, one of the XBRL tags for a customer relationship asset may look like <CustomerRelationshipsMember>. Furthermore, there are certain situations where companies use custom tags that are not part of the standard XBRL business combination taxonomy. Companies may also inappropriately use standard tags or have errors in their XBRL filings.

Centralized Database 108 may store and manage data, analytics, reports, etc. Additional details are provided in U.S. Patent Application 18/142,774, entitled “Automated System and Method for Analyzing and Auditing Financial Data,” filed May 3, 2023, the contents of which are incorporated by reference in their entirety.

Data Aggregation and Analytics Processor 112 may combine and reconcile transaction data from multiple disparate sources represented by Data Source 106. Data Aggregation and Analytics Processor 112 may perform matching operations that associate transaction records from different data sources based on common identifying characteristics such as company names, transaction dates, financial values, etc. In some cases, Data Aggregation and Analytics Processor 112 may implement fuzzy matching algorithms to identify relationships between data records even when exact matches are not available due to variations in naming conventions or data formatting across different source systems. Data Aggregation and Analytics Processor 112 may create unified transaction records that incorporate information from multiple sources to provide comprehensive data sets for analysis and validation operations.

Data Aggregation and Analytics Processor 112 may aggregate data from multiple disparate sources through a matching algorithm. An embodiment of the present invention may map and join data from separate sources including, XBRL, SEC, and Capital IQ. Data Aggregation and Analytics Processor 112 may determine matches based on similarities on buyer/target names between all sources of data. In addition, more complex matches may be determined based on date, purchase price of the transaction in addition to the name of the buyer and target. Other data may be considered. Data Aggregation and Analytics Processor 112 may also seek to eliminate duplicates and display either the most disclosure of a transaction or the version of the transaction disclosure that has received the highest validation status. For example, Data Aggregation and Analytics Processor 112 may apply logic that determines how to handle duplicates. This may involve taking into account date of filing, validation status, whether or not a CapIQ match was found for that transaction, etc.

To aggregate the data from these sources, an embodiment of the present invention executes matching algorithm/decision logic that reconciles/aggregates transaction details from different sources. For example, the matching algorithm may match transaction data from SEC filings with the company information from Capital IQ. This is unique to the tool as these databases are typically used separately.

In addition, Data Aggregation and Analytics Processor 112 may execute a Gen AI powered prompt/persona to perform matching from collected data to supplement and confirm accuracy of the matching algorithm results. In some cases, the Gen AI matching functionality may analyze business names, transaction descriptions, and other textual information to identify relationships between transaction records that might not be detected through conventional matching techniques.

Validation Processor 114 may manage data verification and quality assurance operations for transaction information collected from various data sources. Validation Processor 114 may implement specialized processing modules that handle different categories of transaction data to ensure accuracy and completeness of the information stored in Centralized Database 108. For example, Validation Processor 114 may coordinate validation activities across multiple data types and sources to provide comprehensive verification of transaction records.

Validation Processor 114 utilizes validation definitions including Unvalidated, Validated, and Reviewed statuses to verify transaction status with multiple levels of validation that indicate the degree of review and confirmation applied to each transaction record. An “Unvalidated” status represents that a user may have observed the transaction but did not specifically check off that the data matches with 10-K. This may represent the initial mapping logic inherent in the tool. A “Validated” status represents that at least one user has verified that the information in the tool matches the 10-K. Any user in the database has the permissions to validate a transaction at the first level. A “Reviewed” status indicates that the transaction has been validated and at least one Admin or Business Valuation (BVAL) manager (or above) has verified that the information in the Tool matches the 10-K. This represents the second and final level of verified data in the database. Other definitions and statuses may be implemented to support various use cases, industries and applications. Validation Processor 114 may track validation history and user interactions to maintain audit trails that document the verification process for each transaction record.

Once a transaction has been validated, the values associated with the transaction may be saved/managed and made available to subsequent users, applications, systems, etc. With more data acquired and reviewed / validated, the wealth of information stored within a Centralized Database will expand. Various reports, visualizations and outputs may be generated for analytics and insights.

Validation Processor 114 may include processing modules such as Intangibles 130; Goodwill/PP&E 132; Enterprise Value 134; and Financial Research Platform 136.

Intangibles 130 verifies that intangible assets are mapped to the proper intangible asset category, the remaining useful life (RUL) for each of the assets agrees with the 10-K Factviewer, and the fair values of the intangible assets are complete and accurate. Intangibles 130 may process and categorize intangible asset information extracted from transaction data. Intangibles 130 may categorize intangible assets to provide standardized classifications for valuation analysis. In some cases, Intangibles 130 may apply mapping logic that translates company-specific asset descriptions into standardized categories that enable consistent analysis across different transactions and reporting formats. Intangibles 130 may validate asset categorization, remaining useful life values, and fair value amounts by comparing extracted data against source filing information to ensure accuracy of the intangible asset records.

Goodwill/PP&E 132 verifies that goodwill and property, plant, and equipment (PP&E) values are complete and accurate as compared to a source, such as the 10-K Factviewer. Goodwill/PP&E 132 may manage validation of goodwill and property, plant, and equipment values extracted from transaction filings. Goodwill/PP&E 132 may verify that goodwill amounts and PP&E valuations are accurately captured from source documents and properly categorized within the transaction data structure. In some cases, Goodwill/PP&E 132 may provide functionality for users to review and modify goodwill and PP&E values when discrepancies are identified between extracted data and source filing information. Goodwill/PP&E 132 may maintain validation status indicators that track the level of review applied to goodwill and PP&E data elements within each transaction record.

Enterprise Value 134 verifies that inputs building up to enterprise value (e.g., equity value/purchase price, interest bearing debt, cash, minority interest, and/or preferred interest) are complete and accurate as compared to a source, such as the 10-K Factviewer. Enterprise Value 134 may process and validate enterprise value calculations and related financial metrics for transaction analysis. Enterprise Value 134 may automatically calculate remaining identified net assets and liabilities, intangible assets percentage of enterprise value, acquisition premium, and intangible assets percentage of premium based on validated transaction data inputs. In some cases, Enterprise Value 134 may perform reconciliation calculations that ensure enterprise value components sum correctly and identify potential data inconsistencies that require user review. Enterprise Value 134 may validate purchase price components including debt, cash, non-controlling interest, and preferred interest values that contribute to enterprise value calculations.

Financial Research Platform 136 validates the transaction information (such as Capital IQ information) has been automatically mapped to the transaction. Financial Research Platform 136 may manage integration and validation of data from external financial research platforms. Financial Research Platform 136 supports multiple financial research platforms beyond Capital IQ, with Capital IQ being one example implementation that provides market data and transaction information. In some cases, Financial Research Platform 136 may interface with various financial data providers through application programming interfaces or data feeds that supply complementary information to enhance transaction analysis capabilities. Financial Research Platform 136 may validate the accuracy of financial research data matching by comparing transaction identifiers, company names, and transaction dates across different data sources to ensure proper association of external data with transaction records stored in Centralized Database 108.

An embodiment of the present invention supports various use cases and applications and may be integrated with various systems and services. For example, Audit Analyzer 116 may maintain and manage original source document for audits and provide confirmation/verification to facilitate the overall audit process. Other use cases and applications may be supported.

Audit Analyzer 116 may maintain comprehensive audit trail functionality and provide verification capabilities to support regulatory compliance and data integrity requirements. Audit Analyzer 116 may maintain original source documents for audits and provide confirmation/verification to facilitate the overall audit process by preserving document lineage and tracking data modifications throughout the validation workflow. In some cases, Audit Analyzer 116 may store references to original SEC filings, XBRL documents, and financial research data that serve as supporting evidence for transaction analysis conclusions. Audit Analyzer 116 may implement document retention protocols that ensure source materials remain accessible for audit review and verification purposes. Audit Analyzer 116 may track user interactions, data modifications, and validation activities to create comprehensive audit logs that document the complete history of transaction data processing and review activities.

Audit Analyzer 116 may coordinate with Validation Processor 114 to maintain detailed records of validation status changes, user reviews, and data corrections applied to transaction records stored in Centralized Database 108. In some cases, Audit Analyzer 116 may generate audit reports that summarize validation activities, identify data quality metrics, and provide documentation for regulatory compliance requirements.

Output Interface 118 may represent an interactive interface that provides analysis in various formats, including dashboards, interactive interfaces, and/or other communications. Output Interface 118 may be accessed by various user devices over communication network represented by Network 104. For example, Output Interface 118 may include various interfaces such as dashboards, user interfaces, outputs, etc. Output Interface 118 may manage the presentation and delivery of processed transaction data through multiple output formats and interactive visualization capabilities. Output Interface 118 may generate various output formats including Excel files, PowerBI dashboards, HTML extracts of filings, and zip files containing raw public filings that enable users to access transaction analysis results in formats appropriate for different use cases and analytical requirements. In some cases, Output Interface 118 may customize output formatting based on user preferences, project requirements, or client specifications to ensure that delivered results meet specific analytical or presentation standards. Output Interface 118 may implement data export controls that maintain data security while enabling authorized users to extract transaction information for external analysis or reporting purposes.

Output Interface 118 may also provide a wide range of user interactions including slicing and drill-through capabilities in dashboards with interactive visualizations including summary of transactions, remaining useful life summary, intangibles details, and transaction analysis that enable comprehensive exploration of transaction data patterns and trends. In some cases, Output Interface 118 may generate dynamic visualizations that allow users to filter transaction data by industry, date ranges, asset categories, or financial metrics to focus analysis on specific subsets of the available data. Output Interface 118 may implement interactive charting and graphing capabilities that enable users to explore relationships between different transaction variables and identify patterns that support valuation analysis conclusions. Output Interface 118 may provide comparative analysis features that enable users to benchmark transaction metrics against industry averages or historical trends within Centralized Database 108.

Output Interface 118 provides Gen AI layered on top of the database allowing users to query using natural language and interact with Gen AI through chat features that eliminate the constraints of predefined search criteria and enable more flexible data exploration capabilities. In some cases, Output Interface 118 may implement conversational query interfaces that allow users to request transaction data using written English descriptions rather than structured database queries or predefined filter selections. Output Interface 118 may process natural language queries through Gen AI functionality that interprets user requests and translates them into appropriate database operations to retrieve relevant transaction information. Output Interface 118 may provide interactive chat capabilities that enable users to refine queries, request additional analysis, or explore related transaction data through conversational interactions with the Gen AI system. Output Interface 118 may maintain query history and enable users to save or share natural language queries for reuse in future analysis sessions or collaboration with other system users.

Users 120, 122 may communicate with System 102 via Network 104. System 102 may communicate and integrate with other devices and support various configurations and architectures. System 102 may support interactions on devices including mobile or computing device, such as a laptop computer, a personal digital assistant, a smartphone, a smartwatch, smart glasses, other wearables or other computing devices capable of sending or receiving network signals. System 102 may include computer components such as computer processors, microprocessors and interfaces to support applications including browsers, mobile interfaces, dashboards, interactive interfaces, etc. Other functions and features represented may be supported in various forms and implementations. While FIG. 1 illustrates individual devices or components, it should be appreciated that there may be several of such devices to carry out the various exemplary embodiments.

System 102 may be communicatively coupled to various data sources, as shown by Centralized Database 108, including any suitable data structure to maintain the information and allow access and retrieval of the information. Data Sources may be local, remote, cloud or network based. Communications with Data Sources may be over a network, or communications may involve a direct connection.

Networks may be a wireless network, a wired network or any combination of wireless network and wired network. Although Network 104 is depicted as one network for simplicity, it should be appreciated that according to one or more embodiments, Network 104 may comprise a plurality of interconnected networks, such as, for example, a service provider network, the Internet, a cellular network, corporate networks, or even home networks, or any of the types of networks mentioned above. Data may be transmitted and received via Network 104 utilizing a standard networking protocol or a standard telecommunications protocol.

The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 are depicted, it should be appreciated that other connections and relationships are possible. The system 100 described below may be used to implement the various methods herein, by way of example. Various elements of the system 100 may be referenced in explaining the exemplary methods described herein.

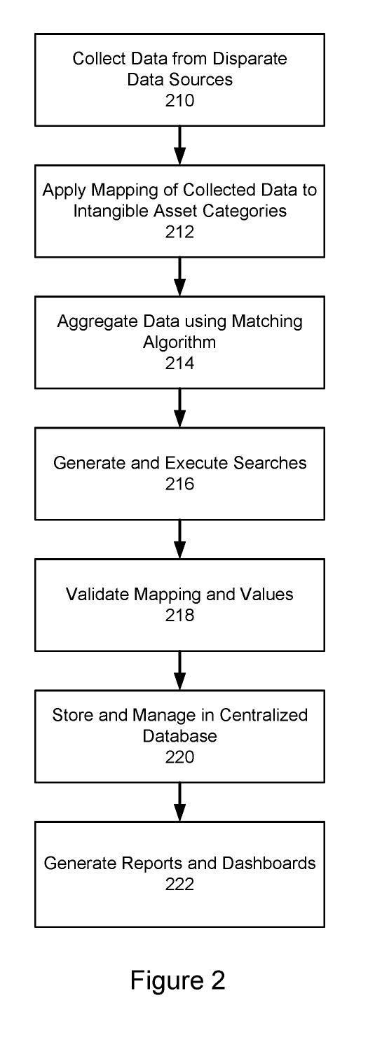

FIG. 2 illustrates an exemplary flowchart, according to an embodiment of the present invention. At step 210, data may be collected from disparate data sources. At step 212, the collected data may be mapped to intangible asset categories. At step 214, data may be aggregated using a matching algorithm. At step 216, searches may be generated and executed. At step 218, mapping and corresponding values may be validated. At step 220, the validated data may be stored and managed in a centralized database. At step 222, reports, dashboards, user interfaces and/or other outputs may be generated. FIG. 2 is an exemplary flowchart, according to an embodiment of the present invention. While the process of FIG. 2 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 210, data may be collected from disparate data sources. An embodiment of the present invention may coordinate retrieving information from Securities and Exchange Commission databases, XBRL repositories, and financial research platforms. Other data sources may be accessed.

At step 212, the collected data may be mapped to intangible asset categories. An embodiment of the present invention may apply mapping algorithms and data standardization procedures to transform collected transaction data into normalized formats suitable for analysis and validation operations. For example, a mapping logic may be applied to translate XBRL tags into standardized financial line items and asset categories. In some cases, Gen AI functionality may be applied to process unstructured text from public filings to extract transaction details that supplement the structured data obtained through XBRL processing. Step 212 may apply asset categorization rules that organize intangible assets according to classifications including Artistic-related, Contract-Based, Customer-Related, Marketing Related, and Technology-based categories.

At step 214, data may be aggregated using a matching algorithm. An embodiment of the present invention may perform data aggregation and matching operations to associate transaction records from different data sources. Matching algorithms may be applied to identify relationships between SEC filing data and financial research platform information based on company names, transaction dates, and financial metrics. In some cases, fuzzy matching logic may accommodate variations in naming conventions and data formatting across different source systems to maximize successful data association rates. In addition, Gen AI matching functionality may be applied to analyze textual descriptions and business information to identify transaction relationships that might not be detected through conventional algorithmic approaches.

At step 216, searches may be generated and executed. After a project has been created, acquisitions may be searched and accessed. For example, multiple searches may be combined within each project. This may be typically done for different reporting units or operating segments within the same client project. Various searches may be created.

Search results may differ based on the construction of the search criteria. Search types may include: custom search, industry search, etc. For custom searches, users may customize their criteria from various options including transaction identifier, buyer company industry, target company industry, etc. For industry searches, users may search by industry sets. Search results may be viewed and further revised.

An embodiment of the present invention is directed to creating searches through Gen AI. Currently, users have a specific list of potential search criteria they may select from to build their own custom searches on top of the database. An embodiment of the present invention is directed to layering Gen AI on top of the database such that the users are not restricted to pre-defined search criteria and may query the database using natural language and interact with Gen AI. An embodiment of the present invention provides customized searches that are not currently available. For example, “customized” is not limited to a current pre-defined criteria and may include available search fields. Edits, historical searches and other actions may be provided to facilitate collaboration across multiple users/teams/locations. In addition, Gen AI may provide an interactive chat feature to facilitate and augment search features and capabilities.

At step 218, mapping and corresponding values may be validated. Mapping logic may be applied to various public company filings. Each company may report and present information in different ways. Mapping logic may be applied to standardize how each company reports assets and other information. In addition, matching logic may be applied across multiple data sources, e.g., SEC filings, Capital IQ, system users, etc.

For each acquisition, various data points may be collected from each transaction. Data points may include: enterprise value inputs (e.g., purchase price, debt, cash, non-controlling interest, preferred interest, etc.), purchase price allocation inputs (intangible assets breakout, goodwill value, property plant and equipment value, etc.), etc.

An embodiment of the present invention may automatically calculate remaining identified net assets and liabilities to reconcile back to the enterprise value which may be mapped to “Other Assets/(Liabilities)”; Intangible Assets % of Enterprise Value; Acquisition Premium (Enterprise Value less tangible net assets); and Intangible Assets % of Premium.

An exemplary validation screen may be split into sections including: (i) Intangibles; (ii) Goodwill/PP&E; (iii) Enterprise Value; and (iv) Capital IQ.

Intangible Assets may include artistic assets (e.g., copyrights, film library, media content, plays, operas, ballet, books, magazines, newspapers, literary works, pictures, photos, etc.); contract based assets (e.g., agreements, licenses, privileges, exchanges, leases, use rights, etc.); customer assets (e.g., advanced booking, customer lists, platforms, programs, relationships, programs, files, records, distributor relationships, financial services, vendor/supplier relationships, etc.); marketing assets (e.g., domain names, brands, trade dress, non-competition agreements, computer software, developed technology, intellectual property, research and development, databases, know-how, trade secrets, etc.).

Goodwill/PP&E (Property, Plant and Equipment) may include assets that represent an amount a buyer pays beyond the book value of a company’s property, plant, and equipment (PP&E). PP&E generally includes physical assets, such as buildings, machines, tools, and office equipment, as well as natural resources like gas, oil, and investments.

For the Purchase Price, a tag may be selected for the correct value associated with the purchase price. The category and value may be updated. The Tool may automatically select any tags that map into cash, debt, non-controlling interest, or preferred interest in order to get to Enterprise Value. Users may edit the amount picked up or manually add a row to arrive at Enterprise Value.

Users may validate the Capital IQ transaction information that has been automatically mapped to the transaction. If the mapped transaction is correct, a user may confirm that the Capital IQ is mapped to correct transaction. If the mapped transaction is incorrect, a user may modify the Capital IQ mapping. For example, the user may select filing period, which target company name, and which Capital IQ Transaction ID are correct.

According to an embodiment of the present invention, there may be multiple levels of validation. After modifications have been saved, transaction may be marked as “Validated” to indicate that a user has confirmed the accuracy of the data points and transaction information. This serves as the first level of validation. Once a transaction is marked as “Validated” is becomes eligible for a secondary layer of review by admin users.

Once an admin user reviews the transaction, the user may mark the transaction as “reviewed,” meaning the transaction has been reviewed by two users. Once a transaction has been marked reviewed it will show two check marks under the validate category.

At step 220, the validated data may be stored and managed in a centralized database. The validated data may be leveraged across offices, applications, industries, etc.

At step 222, reports, dashboards, user interfaces and/or other outputs may be generated. Dashboards may include: summary of transactions; remaining useful life (RUL) summary; intangibles details (including average intangible value and average percentage of enterprise value, primary intangible asset per transaction, goodwill distribution as a percentage of purchase price); intangibles over premium paid (e.g., premium breakdown on an aggregated level including intangibles percentage of premium and premium paid distribution); purchase price allocation breakdown (e.g., detailed view of aggregated purchase price); transaction analysis (e.g., detailed view of intangible distribution as a percentage of purchase price and a free form intangible relationship analysis); reports dashboard displaying underlying data used within the dashboards, etc. Other reporting capabilities may include: slicing and drilldown capabilities.

For example, reports may include Benchmarking Data; Acquired Asset as a percentage of Business Enterprise Value (BEV); Acquired intangible asset as a percentage of BEV less Tangible Assets, net and Remaining Useful Life.

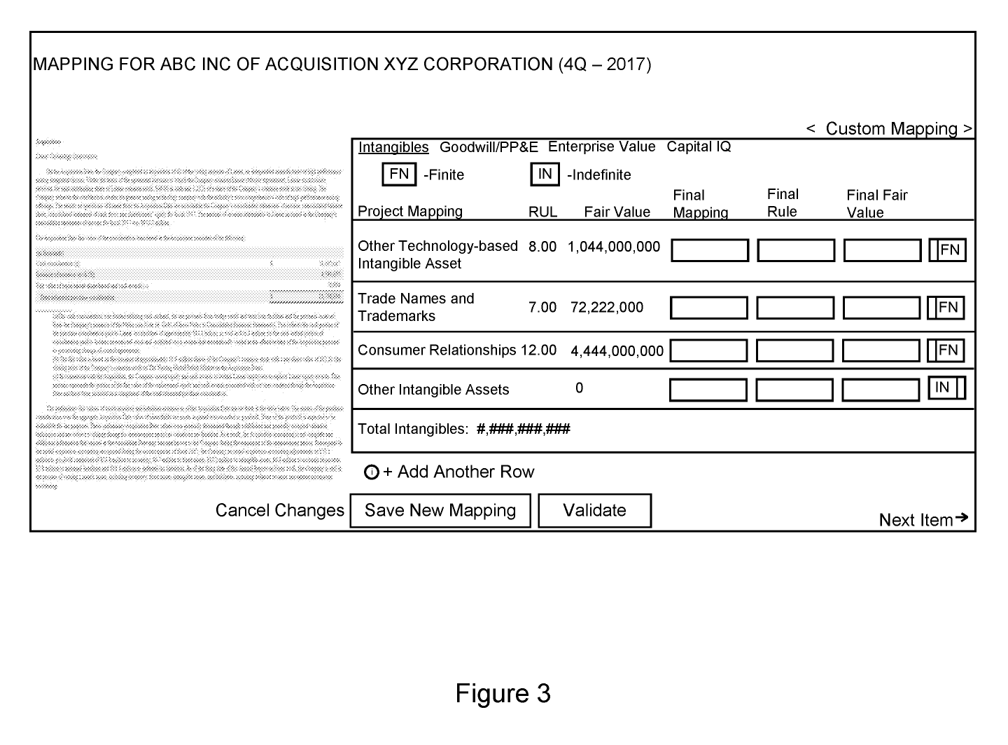

FIG. 3 illustrates an exemplary user interface, according to an embodiment of the present invention. FIG. 3 provides a comprehensive user interface for mapping acquisition data that enables users to validate and modify transaction information extracted from public filings. The user interface displays transaction details for ABC INC's acquisition of XYZ CORPORATION during the fourth quarter of 2017, presenting a structured layout that organizes different categories of transaction data into distinct sections. The interface includes custom mapping sections that correspond to the major components of purchase price allocation analysis, including intangibles, goodwill and property, plant, and equipment, enterprise value calculations, and financial research platform data integration. The user interface may implement a tabbed navigation structure that allows users to focus on specific data categories while maintaining access to related information across different validation areas. In some cases, the interface may provide visual indicators and status flags that communicate data validation states and user interaction requirements throughout the mapping process

As shown in FIG. 3, the user interface shows a report (on the left) and corresponding interfaces (on the right) for Intangibles, Goodwill/PP&E, Enterprise Value and Capital IQ. For Intangibles, FIG. 3 illustrates Project Mapping, RUL, Fair Value, Final Mapping, Final RUL, and Final Fair value. On the left, FIG. 3 illustrates relevant source data.

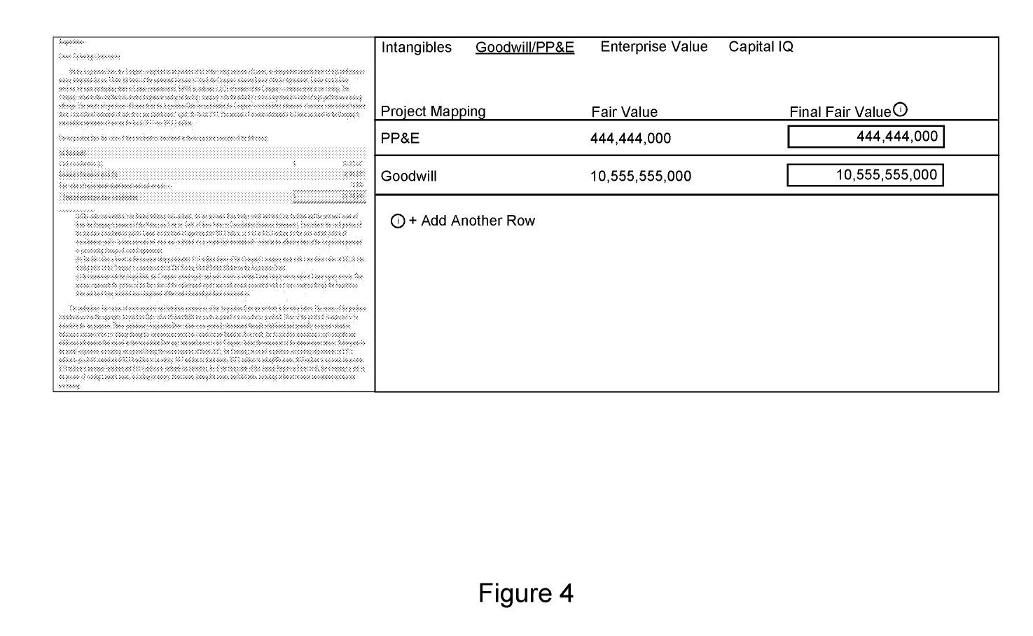

FIG. 4 illustrates an exemplary user interface, according to an embodiment of the present invention. For Goodwill/PP&E, FIG. 4 illustrates Project Mapping, Fair Value and Final Fair Value. On the left, FIG. 4 illustrates relevant source data.

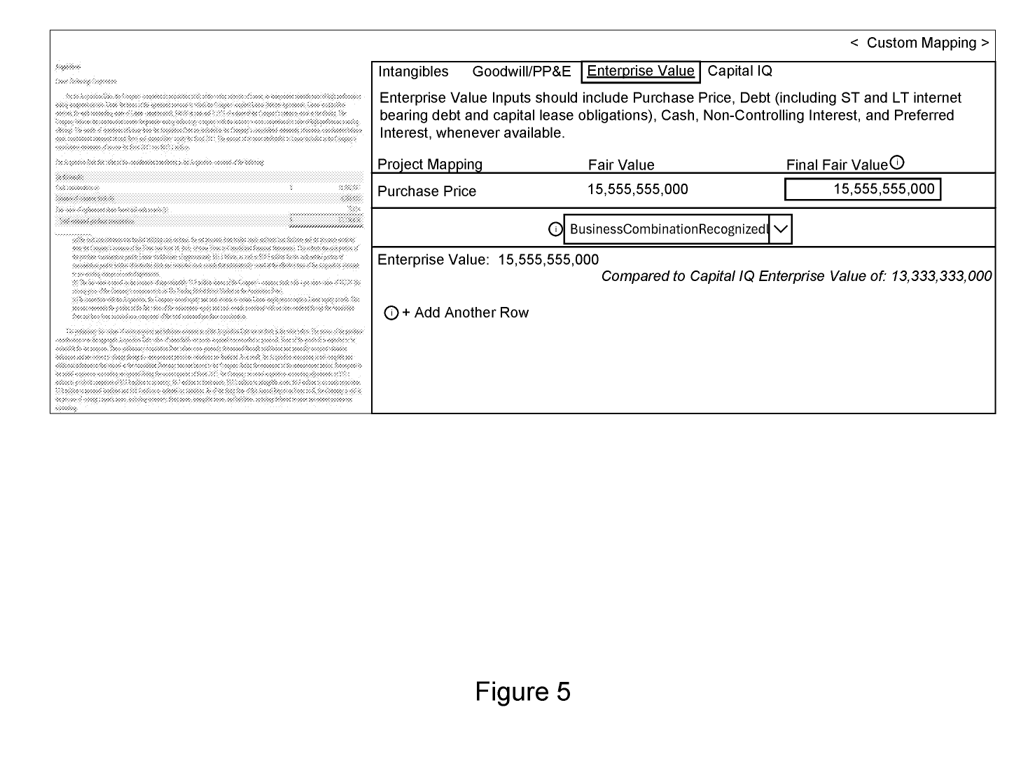

FIG. 5 illustrates an exemplary user interface, according to an embodiment of the present invention. For Enterprise Value, FIG. 5 illustrates Project Mapping, Fair Value, Final Fair Value and Enterprise Value. Enterprise Value inputs should include Purchase Price, Debt (including ST and LT interest bearing debt and capital lease obligation), Cash, Non-Controlling Interest, and Preferred Interest, whenever available. On the left, FIG. 5 illustrates relevant source data.

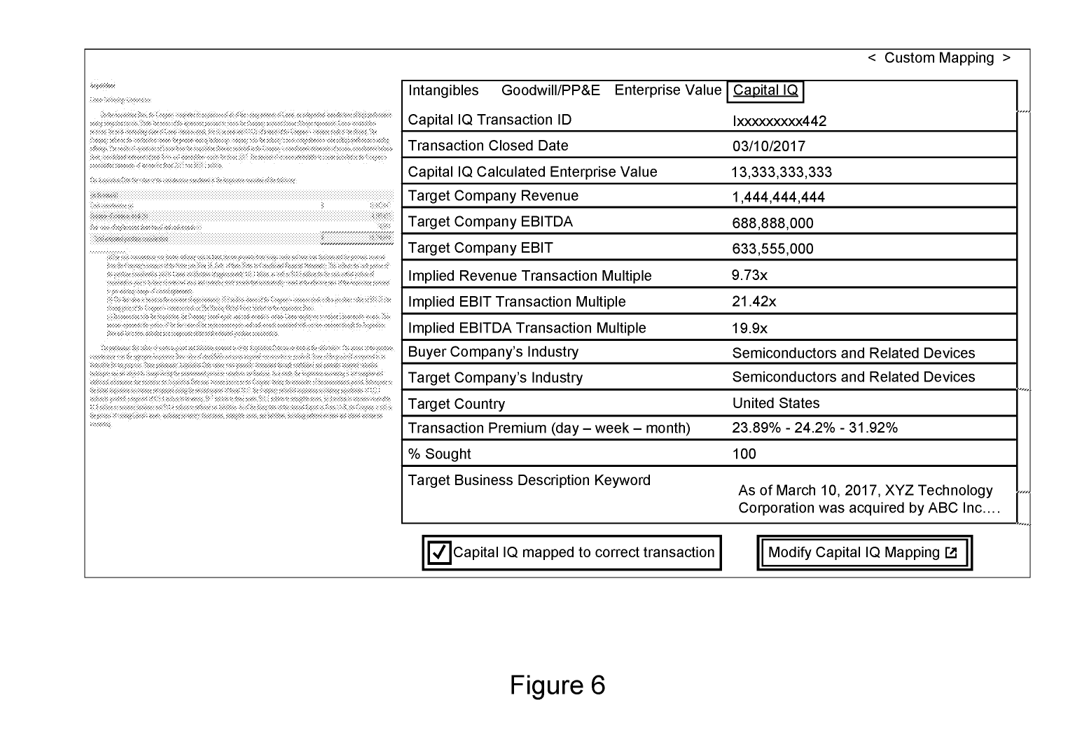

FIG. 6 illustrates an exemplary user interface, according to an embodiment of the present invention. FIG. 6 provides a comprehensive user interface for displaying and validating transaction information that enables users to review and confirm the accuracy of automatically mapped data from multiple sources. The transaction information display may support multiple data source integrations that combine Securities and Exchange Commission filing data with financial research platform information to present comprehensive transaction profiles for user review and validation activities.

For Capital IQ, FIG. 6 illustrates Capital IQ transaction ID, transaction closed date, calculated enterprise value, target company revenue, target company EBITDA, target company EBIT, implied revenue transaction multiple, implied EBIT transaction multiple, implied EBITDA transaction multiple, buyer company’s industry, target company’s industry, target country, transaction premium, percentage sought, and target business description keyword. On the left, FIG. 6 illustrates relevant source data.

The Intangibles Analytics Tool may incorporate Generative Artificial Intelligence (Gen AI) by executing a persona to perform data retrieval, data aggregation, and dynamic data filtering with high accuracy, speed and confidence across multiple operational domains within the purchase price allocation benchmarking framework. The Gen AI persona implementation may utilize specialized knowledge configurations that simulate financial valuation consulting expertise to enhance the accuracy and reliability of automated data processing operations. In some cases, the Gen AI persona may be configured with comprehensive understanding of accounting standards, transaction analysis methodologies, and industry-specific valuation practices that enable sophisticated interpretation of complex financial documents and data structures. The persona-based approach may provide contextual awareness that enables the Gen AI system to make informed decisions about data extraction, categorization, and validation activities that would traditionally require human expertise and judgment. The Gen AI persona functionality may operate across multiple processing stages simultaneously to provide comprehensive analytical support throughout the transaction data lifecycle from initial collection through final report generation.

The Gen AI persona implementation may execute specialized data retrieval operations that process unstructured text documents, financial statements, and regulatory filings to extract relevant transaction information with enhanced accuracy compared to traditional algorithmic approaches. The persona-driven data retrieval functionality may analyze document context, financial terminology, and transaction structures to identify and extract asset valuations, purchase price components, and intangible asset classifications that align with established accounting frameworks and valuation methodologies. In some cases, the Gen AI persona may implement natural language processing capabilities that interpret complex financial narratives and translate qualitative business descriptions into structured data elements suitable for quantitative analysis and benchmarking operations. The data retrieval persona may maintain consistency across different document formats and reporting styles by applying standardized interpretation rules while adapting to variations in company-specific disclosure practices and regulatory filing requirements. The persona-based data retrieval system may provide confidence scoring mechanisms that indicate the reliability of extracted information and flag potential areas where human review may enhance data quality and accuracy.

The data aggregation capabilities of the Gen AI persona may perform sophisticated matching operations that associate transaction records from disparate data sources based on complex relationship analysis that extends beyond simple name and date matching algorithms. The persona-driven aggregation functionality may analyze business descriptions, industry classifications, financial metrics, and transaction characteristics to identify relationships between data records that might not be apparent through conventional matching techniques. In some cases, the Gen AI persona may resolve naming inconsistencies, corporate structure variations, and temporal data discrepancies that commonly occur when combining information from multiple financial databases and regulatory filing systems. The aggregation persona may implement fuzzy logic capabilities that accommodate variations in data formatting, currency representations, and measurement units while maintaining mathematical accuracy and data integrity throughout the consolidation process. The persona-based aggregation system may provide relationship confidence indicators that communicate the strength of data associations and enable users to review and validate automated matching decisions when additional verification may be warranted.

The data source expansion capabilities enable the system to extend beyond US transactions to include foreign transactions from international companies through integration with global regulatory databases and international financial reporting systems. The international transaction integration functionality may accommodate different accounting standards, currency systems, and regulatory filing requirements that vary across different jurisdictions and market environments. In some cases, the expanded data source capabilities may implement currency conversion algorithms that normalize financial values to common denominators while preserving original transaction data for audit trail and verification purposes. The international data integration system may provide country-specific data processing rules that account for variations in disclosure requirements, filing formats, and regulatory frameworks that govern transaction reporting in different markets. The global transaction database may include mapping logic that translates international accounting standards and asset classification systems into standardized categories that enable comparative analysis across different regulatory environments and market jurisdictions.

The international transaction processing capabilities may implement language translation functionality that enables extraction and analysis of transaction data from filings submitted in different languages while maintaining accuracy and context throughout the translation and data extraction process. The multi-language processing system may provide specialized financial terminology translation that preserves technical accuracy and regulatory compliance requirements across different linguistic and cultural contexts. In some cases, the international data processing functionality may implement region-specific validation rules that account for local accounting practices, regulatory requirements, and market conventions that influence transaction disclosure and reporting practices. The global data integration capabilities may provide comparative analysis tools that enable users to benchmark transaction metrics across different markets while accounting for regional variations in valuation methodologies, market conditions, and regulatory environments. The international transaction database may support multi-currency analysis capabilities that enable users to conduct comparative studies across different economic environments while maintaining mathematical accuracy and analytical relevance.

The system architecture implements technical improvements to computer functionality that address specific technological problems in financial data processing and analysis. The computer-implemented system provides concrete technological solutions that enhance the operation of computer systems by implementing specialized data collection interfaces, mapping algorithms, and validation processors that transform disparate financial data sources into standardized, analyzable formats. In some cases, the system may overcome technical limitations of conventional database systems by implementing Gen AI personas that perform sophisticated data extraction, matching, and filtering operations that exceed the capabilities of traditional algorithmic approaches. The technical implementation may include specialized XBRL parsing logic, fuzzy matching algorithms, and multi-source data aggregation capabilities that solve specific problems related to inconsistent data formats, naming conventions, and disclosure practices across different financial reporting systems.

The computer processor executes specific technical processes that improve data processing efficiency and accuracy through automated mapping algorithms that translate company-specific asset descriptions into standardized categories according to established accounting frameworks. The mapping algorithm implementation may apply complex logic that processes eXtensible Business Reporting Language data structures and converts unstructured text from public filings into structured data elements suitable for quantitative analysis. In some cases, the technical solution may implement validation processors with specialized modules that perform automated consistency checks, mathematical reconciliation, and data quality assessments that enhance the reliability and accuracy of financial analysis operations. The system may provide technical improvements to user interface functionality through interactive dashboard capabilities that enable real-time data exploration, filtering, and visualization operations that transform raw transaction data into actionable analytical insights.

The centralized database implements technical data management capabilities that solve specific problems related to data normalization, duplicate elimination, and multi-source integration across disparate financial information systems. The database architecture may provide technical solutions for handling variations in currency representations, measurement units, and temporal data formats while maintaining mathematical accuracy and data integrity throughout the consolidation process. In some cases, the technical implementation may include automated data validation rules, quality scoring algorithms, and confidence indicators that enhance the reliability of automated data processing operations beyond conventional database management capabilities. The system architecture may implement technical preservation protocols with automated retention scheduling, secure storage procedures, and audit trail functionality that provide concrete improvements to data management and compliance capabilities within computer-based financial analysis systems.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible, and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the System software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages will be apparent to those skilled in the art from consideration of the specification and practice of the embodiments disclosed herein. The specification and examples should be considered exemplary.

What is claimed is:

1. A computer-implemented system that implements a purchase price allocation benchmarking and analytics tool, the system comprising:
a data collection input interface that collects data from a plurality of disparate data sources;
a centralized database that stores, normalizes and manages the collected data; and
a computer processor that is coupled to the data collection input and the centralized database and further programmed to perform the steps of:
collecting, via the data collection input interface, transaction data from the plurality of disparate data sources comprising company public filings, eXtensible Business Reporting Language (XBRL) data and financial research platform data;
executing, via the computer processor, a mapping algorithm that normalizes and standardizes the transaction data from company public filings;
executing, via the computer processor, a matching algorithm that associates the transaction data with corresponding financial research platform data;
validating, via the computer processor, the transaction data to identify a validation status representing a level of validation;
generating, via the computer processor, one or more searches for the validated transaction data; and
presenting, via a user interface, an interactive dashboard that comprises source data content and corresponding analytics relating to the transaction data specific to a combination of: Intangibles data; Goodwill / property, plant, and equipment (PP&E) data; Enterprise Value; or Financial Research Data.

2. The system of claim 1, wherein a first Generative AI persona is integrated with the data collection input interface to collect the transaction data from the plurality of disparate data sources.

3. The system of claim 2, wherein the first Generative AI persona is configured with specialized knowledge about financial valuation consulting and transaction analysis to enhance accuracy of data extraction from unstructured text sources.

4. The system of claim 1, wherein a second Generative AI persona is integrated with the computer processor to execute the matching algorithm to associate the transaction data with corresponding financial research platform data.

5. The system of claim 4, wherein the second Generative AI persona analyzes business names, transaction descriptions, and textual information to identify one or more relationships between transaction records.

6. The system of claim 1, wherein a third Generative AI persona is integrated with the computer processor to generate one or more searches responsive to a natural language user input.

7. The system of claim 6, wherein the third Generative AI persona processes one or more natural language queries through a conversational query interface that allow a user to request transaction data.

8. The system of claim 1, wherein the validation status is determined through multi-level validation comprising: an unvalidated status representing transaction data that has been collected but not yet verified by a system user, a validated status indicating that at least one user has confirmed accuracy of the transaction data, and a reviewed status representing that transaction data has undergone both initial validation and secondary review by one or more administrative users.

9. The system of claim 1, wherein the mapping algorithm applies a mapping logic that translates company-specific asset descriptions into standardized asset classifications.

10. The system of claim 1, wherein the interactive dashboard provides one or more interactive visualizations comprising one or more of: a summary of transactions, a remaining useful life summary, one or more intangibles details, or transaction analysis.

11. A computer-implemented method that implements a purchase price allocation benchmarking and analytics tool, the method comprising the steps of:
collecting, via a data collection input interface, transaction data from a plurality of disparate data sources comprising company public filings, eXtensible Business Reporting Language (XBRL) data and financial research platform data;
executing, via a computer processor, a mapping algorithm that normalizes and standardizes the transaction data from company public filings;
executing, via the computer processor, a matching algorithm that associates the transaction data with corresponding financial research platform data;
validating, via the computer processor, the transaction data to identify a validation status representing a level of validation;
generating, via the computer processor, one or more searches for the validated transaction data; and
presenting, via a user interface, an interactive dashboard that comprises source data content and corresponding analytics relating to the transaction data specific to a combination of: Intangibles data; Goodwill / property, plant, and equipment (PP&E) data; Enterprise Value; or Financial Research Data.

12. The method of claim 11, wherein a first Generative AI persona is integrated with the data collection input interface to collect the transaction data from the plurality of disparate data sources.

13. The method of claim 12, wherein the first Generative AI persona is configured with specialized knowledge about financial valuation consulting and transaction analysis to enhance accuracy of data extraction from unstructured text sources.

14. The method of claim 11, wherein a second Generative AI persona is integrated with the computer processor to execute the matching algorithm to associate the transaction data with corresponding financial research platform data.

15. The method of claim 14, wherein the second Generative AI persona analyzes business names, transaction descriptions, and textual information to identify one or more relationships between transaction records.

16. The method of claim 11, wherein a third Generative AI persona is integrated with the computer processor to generate one or more searches responsive to a natural language user input.

17. The method of claim 16, wherein the third Generative AI persona processes one or more natural language queries through a conversational query interface that allow a user to request transaction data.

18. The method of claim 11, wherein the validation status is determined through multi-level validation comprising: an unvalidated status representing transaction data that has been collected but not yet verified by a system user, a validated status indicating that at least one user has confirmed accuracy of the transaction data, and a reviewed status representing that transaction data has undergone both initial validation and secondary review by one or more administrative users.

19. The method of claim 11, wherein the mapping algorithm applies a mapping logic that translates company-specific asset descriptions into standardized asset classifications.

20. The method of claim 11, wherein the interactive dashboard provides one or more interactive visualizations comprising one or more of: a summary of transactions, a remaining useful life summary, one or more intangibles details, or transaction analysis.
